(19) United States
(12) Patent Application Publication
(10) Pub. No.: US 2007/0077783 A1
(43) Pub. Date: Apr. 5, 2007

(54) Rotary connector system

(75) Inventors: David L. Becker, White Lake, MI (US); Boris G. Karasik, Commerce Township, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 11/241,112

(22) Filed: Sep. 30, 2005

(51) Int. Cl. H01R 39/00

(52) U.S. Cl. 439/13; 324/207.2

(57) ABSTRACT

A system for conducting an electrical signal from a first device to a second device, which members are relatively rotatable is provided. The system includes first and second Hall effect assemblies. The first Hall effect assembly is rotatable upon rotation of one of the devices, and the second Hall effect assembly is associated with the other one of the devices. A ferromagnetic part is interposed between the Hall effect assemblies. One of the Hall effect assemblies creates a magnetic flux field in the ferromagnetic part. The ferromagnetic part transmits the magnetic flux field from one of the Hall effect assemblies to the other Hall effect assembly which other Hall effect assembly provides an electrical control signal.

### TECHNICAL FIELD

The present invention relates to a system for conducting an electrical signal from a first electrical device to a second electrical device, which devices are relatively rotatable. For example, the invention relates to a system where a first device is mounted on a vehicle steering wheel, which first device comprises an air bag module, audio control, speed control, or horn switch and is in electrical communication with a second device mounted on the vehicle such as an occupant restraint module, powertrain module body controller, or the like, which require electrical communication of signals during rotation of the steering wheel.

### BACKGROUND OF THE INVENTION

Systems used to transmit electrical signals from a first electrical device mounted on a rotating member, such as a vehicle steering wheel, to a second electrical device mounted on the vehicle require communication of the signals during rotation of the rotating member. In the case of a steering wheel, a flat flexible cable called a clockspring is commonly used to provide the electrical communication yet allow the steering wheel to rotate. However, the movement of the clockspring during the rotation of the steering wheel creates areas of stress in the clockspring. This may cause a fault that results in the failure of vehicle stability control, airbag, horn or other devices controllable from the steering wheel. The present invention is not subject to the above mentioned problems.

### SUMMARY OF THE INVENTION

The present invention relates to a system for conducting an electrical signal from a first electrical device to a second electrical device, which devices are relatively rotatable. The system includes first and second Hall effect assemblies. The first Hall effect assembly is rotatable upon rotation of one of the devices, and the second Hall effect assembly is associated with the other one of the devices. A ferromagnetic part is interposed between the Hall effect assemblies. One of the Hall effect assemblies creates a magnetic flux field in the ferromagnetic part. The ferromagnetic part transmits the magnetic flux field from the one of the Hall effect assemblies to the other Hall effect assembly which other Hall effect assembly provides an electrical control signal.

The present invention also relates to a system for conducting electrical signals to a non-rotatable electrical device in response to actuation of an actuator on a rotatable member rotatable relative to the electrical device. The system includes a first ferromagnetic ring and a second ferromagnetic ring spaced apart from the first ferromagnetic ring and concentric with the first ferromagnetic ring. The first and second ferromagnetic rings are rotatable with the rotatable member. A Hall effect assembly is electromagnetically coupled with the first and second rings which rings transmit magnetic flux. The Hall effect assembly and the first and second rings generate a control signal upon actuation of the actuator, which control signal triggers actuation of the electrical device.

### BRIEF DESCRIPTION OF THE DRAWINGS

The foregoing and other features of the invention will become more apparent to one skilled in the art upon consideration of the following description of the invention and the accompanying drawings in which:

FIG. 1 is a schematic perspective view of a system in accordance with a first embodiment of the present invention;

FIG. 2 is a schematic representation of a circuit of the system of FIG. 1;

FIG. 3 is a view similar to FIG. 2 showing the circuit in an operative condition; and

FIG. 4 is a schematic perspective view in accordance with a second embodiment of the present invention.

### DESCRIPTION OF A PREFERRED EMBODIMENT

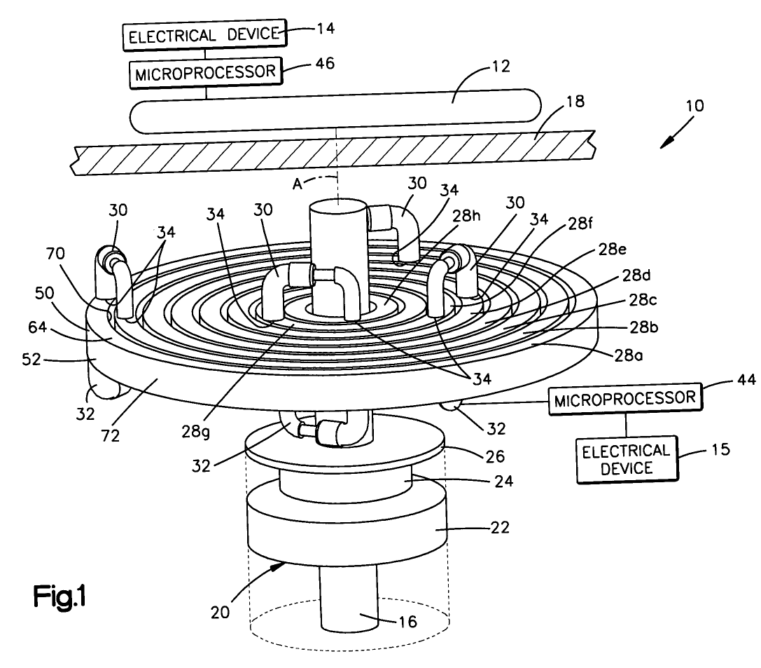

As representative of the present invention, FIG. 1 illustrates a system 10 for conducting an electrical signal from a first electrical device 14 to a second electrical device 15, which devices are relatively rotatable.

In FIG. 1, a vehicle steering wheel 12 is illustrated. The steering wheel 12 may have an electrical device, such as a switch and a switch actuator 14 mounted on the steering wheel. The electrical device 14 actuates an electrical device 15 on the vehicle. An example would be a switch (actuator) mounted on the steering wheel 12 and an electrical device 15 such as a horn, vehicle lights, cruise control or the like, actuated by the switch, and which is mounted on the vehicle. Therefore, the electrical device 14 rotates relative to the electrical device 15 actuated by the actuator of the electrical device 14. Also, an electrical actuator 14 may be on the vehicle and an electrical device 15 may be mounted on the steering wheel and be actuated by the actuator.

An example would be a crash sensor (actuator) mounted on the vehicle and an air bag mounted on the steering wheel 12.

The steering wheel 12 is mounted on a steering wheel shaft 16. A housing 18 (shown schematically) partially encloses the steering wheel shaft 16. The steering wheel shaft 16 is made of steel or any other suitable material.

A transformer 20 is associated with the steering wheel shaft 16. The transformer 20 includes concentric primary and secondary coils 22, 24 wound around the steering wheel shaft 16. The primary coil 22 is mounted to the housing 18, and thus is fixed with respect to the housing 18. The secondary coil 24 is connected to the steering wheel shaft 16 and rotates with the steering wheel shaft 16. Power from a power source is transmitted to the transformer 20. In particular, the power from the power source energizes the primary coil 22, which, upon being energized, creates a magnetic field through the shaft 16. The magnetic field then acts upon the secondary coil 24 to develop the proper amount of voltage and current required by the system 10. In this respect, the shaft 16 functions as a transformer core.

The system 10 includes a plurality of concentric magnetic flux conductive bands 28a-h encircling the steering wheel shaft 16. The bands 28 are radially spaced apart from each other and are connected to the steering wheel shaft 16 in a suitable manner. All of the concentric bands 28 rotate together with the steering wheel shaft 16. The bands 28 are composed of a ferromagnetic material such as iron or steel to carry magnetic flux. The bands 28 are magnetically isolated from each other by the radial air gaps between the bands and by other structure (not shown) as required.

Each band 28 is centered on the axis A of shaft 16. Each band 28 extends 360° (degrees) around the shaft 16. Thus, each band 28 is a closed ring. Each band 28 has a uniform identical cross section that is rectangular in shape. Each band lies in a radial plane that extends transverse to the axis A of the shaft through the axis A of the shaft 16. Each band 28 has a flat upper surface 64 and a flat lower surface 66, which surfaces are parallel to each other and lie in a plane transverse to the rotating axis A of the band 28. Each band 28 has radially spaced inner and outer circular surfaces 70, 72 that are concentric.

The bands 28 are isolated from the magnetic field in the shaft 16. A can 26, made of a suitable material, is located between the transformer 20 and the bands 28 and totally encloses the coils 22, 24 of the transformer to isolate the concentric bands 28 from the transformer 20 in order to minimize electromagnetic interference. The can 26 can be eliminated and a plate or other structure can perform the function of isolating the bands 28 from the transformer 20.

A plurality of upper U-shaped Hall assemblies 30 are positioned above the bands 28. A plurality of lower U-shaped Hall assemblies 32 are positioned below the bands 28. The upper Hall effect assemblies 30 are secured to the steering wheel shaft 16, and thus, are fixed relative to the steering wheel shaft 16.

Therefore, the upper Hall effect assemblies 30 rotate with the steering wheel 12 and the steering wheel shaft 16. The lower Hall effect assemblies 32 are secured to the steering wheel housing 18 and thus, are fixed relative to the housing 18. Therefore, the lower Hall effect assemblies 32 do not rotate with the steering wheel 12 or with the steering wheel shaft 16. Also, the upper Hall effect assemblies 30 rotate relative to the lower Hall effect assemblies 32.

The Hall assemblies are grouped into a plurality of conductive pairs. Each pair comprises an upper Hall assembly 30 and a lower Hall assembly 32. The steering wheel may have a plurality of electrical devices 14 (only one being shown in the drawings) mounted on the steering wheel 12 which control a plurality of electrical devices 15 (only one being shown in the drawings). Each pair of an upper Hall effect assembly and a lower Hall effect assembly provides a structure for conducting electricity between an electrical device 14 and electrical device 15.

For simplicity purposes, the configuration and operation related to the electrical devices 14, 15 associated with a pair of an upper Hall effect assembly 30 and a lower Hall effect assembly 32 will be described. The remaining configurations and their operations related to other electrical devices 14, 15 and other pairs of Hall effect assemblies 30, 32 are similar.

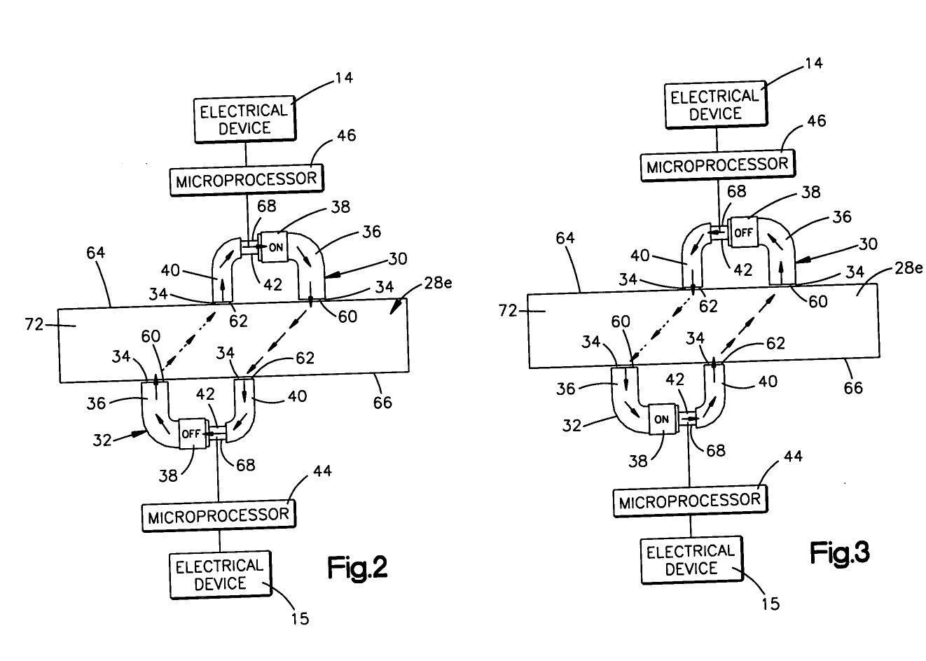

As best seen in FIGS. 2 and 3, the upper Hall effect assembly 30 includes a first leg defining a ferromagnetic core 36 and an electromagnetic coil 38 wound around the portion of the core 36 in the bight portion 68 of the U-shaped Hall effect assembly. The coil 38, upon being energized creates a magnetic field through the core 36. The upper Hall effect assembly 30 further includes a second leg defining a magnetic pole 40, and a Hall effect device 42 positioned in the bight portion 68 between the coil 38 and the pole 40. A magnetic field at the pole 40 causes the Hall effect device 42 to change its output state and output Hall voltage. The Hall effect device 42 is a standard unipolar switching device in which the output of the Hall effect device 42 is affected with the magnetic field present at only the one pole 40.

The upper Hall effect assembly 30 extends upwardly parallel to the axis A of the shaft 16. The bight portion 68 is located at the top of the upper Hall effect assembly 30 and lies in a plane that extends transverse to the axis A of the steering wheel shaft 16.

As seen in FIG. 1, the upper Hall effect assembly 30 is oriented such that the flat free end 60 of the core 36 is parallel to, aligned with or directly above, and spaced from the upper surface 64 of the band 28e, and the flat free end 62 of the pole 40 is parallel to, aligned with or directly above, and spaced from the upper surface 64 of the band 28f.

One air gap 34 is formed between the free end 60 of the upper Hall effect assembly 30 and the upper surface 64 of the band 28e, and another air gap 34 is also formed between the free end 62 of the upper Hall effect assembly 30 and the upper surface 64 of the band 28f. The small air gaps 34 are sufficient to allow strong electromagnetic coupling between the bands 28e, 28f and the upper Hall effect assembly 30 associated with the bands 28e, 28f. The core 36 and pole 40 have uniform circular cross sections that are sized to optimize the balance between a desired large area of magnetic flux transmission, which such large transmission favors large cross sections, and a desired low cost of fabrication, which such fabrication favors small cross sections.

The lower Hall effect assembly 32 also includes a first leg defining a ferromagnetic core 36 and an electromagnetic coil 38 wound around the portion of the core 36 in the bight portion 68 of the U-shaped Hall effect assembly. The coil 38, upon being energized, creates a magnetic field through the core 36. The lower Hall effect assembly 32 further includes a second leg defining a magnetic pole 40, and a Hall effect device 42 positioned in the bight portion 68 between the coil 38 and the pole 40. A magnetic field at the pole 40 causes the Hall effect device 42 to change its output state and output Hall voltage. The Hall effect device 42 is a standard unipolar switching device.

The lower Hall effect assembly 32 extends downwardly parallel to the axis A of the steering wheel shaft 16. The bight portion 68 is located at the bottom of the lower Hall effect assembly 32 and lies in a plane that extends transverse to the axis A of the steering wheel shaft 16. The lower Hall effect assembly 32 is oriented such that the flat free end 60 of the core 36 is parallel to, aligned with or directly below, and spaced from the lower surface 66 of the band 28f, and the flat free end 62 of the pole 40 is parallel to, aligned with or directly below, and spaced from the upper surface 64 of the band 28e.

One air gap 34 is formed between the free end 60 of the lower Hall effect assembly 32 and the lower surface 66 of the band 28f, and another air gap 34 is also formed between the free end 62 of the lower Hall effect assembly 32 and the lower surface 66 of the band 28e. The small air gaps 34 are sufficient to allow strong electromagnetic coupling between the bands 28e, 28f and the lower Hall effect assembly 32 associated with the bands 28e, 28f. The cross sections of the core 36 and pole 40 have uniform circular cross sections that are sized to optimize the balance between a desired large area of magnetic flux transmission, which such large transmission favors large cross sections, and a desired low cost of fabrication of the Hall effect assembly, which such fabrication favors a small cross sections.

A first microprocessor 44 is electrically coupled to the Hall effect device 42 of the lower Hall effect assembly 32. One output of the first microprocessor 44 is electrically coupled to the electrical device 15. The first microprocessor 44 and electrical device 15, such as a radio in the instrument panel of the vehicle, is fixed with respect to the lower Hall effect assembly 32. The microprocessor 44, like the Hall effect assemblies 32, does not rotate with the steering wheel 12. The first microprocessor 44 also includes further outputs that are electrically coupled to other respective electrical devices 15 and further inputs electrically coupled to the other lower Hall effect assemblies 32. The transformer 20 is connected to the first microprocessor 44 to provide power to the Hall effect devices 42 of the lower Hall effect assemblies 32 and the electrical devices 15.

A second microprocessor 46 includes an output that is electrically coupled to the Hall effect device 42 of the upper Hall effect assembly 30. An input of the second microprocessor 46 is electrically coupled to the electrical device 14. The second microprocessor 46 and electrical device 14, such as a horn switch or radio control switch on the steering wheel 12, rotates with the steering wheel 12 and upper Hall effect assembly 30. The second microprocessor 46 includes further inputs that are electrically coupled to other respective electrical devices 14 and further outputs that are electrically coupled to the other upper Hall effect assemblies 30.

Referring to FIG. 2, upon actuation of the electrical device 14, short powerful pulses of electrical energy from a power source are encoded by the second microprocessor 46 and inputted into the coil 38 of the upper Hall effect assembly 30. As depicted by the arrows in FIG. 2, the coil 38 generates a magnetic field that travels through the core 36 of the upper Hall effect assembly 30, the band 28e, and the pole 40 of the lower Hall effect assembly 32. The magnetic field causes the Hall effect device 42 of the lower Hall effect assembly 32 to change its output state and output an electrical signal to the first microprocessor 44. The first microprocessor 44 decodes the signal into the proper signal to actuate the electrical device 15. The magnetic field also travels through the coil 38 and core 36 of the lower Hall effect assembly 32, the band 28f (FIG. 1), and the pole 40 and Hall effect device 42 of the upper Hall effect assembly 30. The magnetic field further travels across the air gaps 34.

Electrical signals can also communicate from the electrical device 15 to the electrical device 14 to operate the electric device 14. In particular, referring to FIG. 3, upon actuation of the device 15, such as an acceleration sensor in this case, short powerful negative pulses of electrical energy from a power source are encoded by the microprocessor 46 and inputted into the coil 38 of the lower Hall effect assembly 32. As depicted by the arrows in FIG. 3, the coil 38 generates a magnetic field that travels through the Hall effect device 42, pole 40 of the lower Hall effect assembly 32, the band 28e, and the core 36, coil 38, and Hall effect device 42 of the upper Hall effect assembly 30. The magnetic field causes the Hall effect device 42 to change its output state and output an electrical signal to the second microprocessor 46. The second microprocessor 46 decodes the pulses into the proper signal to actuate the electrical device 14 such as an air bag, which is located in the steering wheel 12. The magnetic field also travels through the pole 40 of the upper Hall effect assembly 30, the band 28f (FIG. 1), the core 36 and coil 38 of the lower Hall effect assembly 32 and Hall effect device 42 of the lower Hall effect assembly 32. The magnetic field further travels across the air gaps 34. The polarity of the Hall effect devices 42 are chosen so that only the Hall effect device 42 of the lower Hall effect assembly 32 has the correct field direction to trip and change its output state.

One pair of an upper Hall effect assembly 30 and a lower Hall effect assembly 32 is magnetically coupled to the adjacent outer bands 28a, 28b to conduct electrical signals between a first pair comprising an electrical device 14 and an electrical device 15. Another pair of an upper Hall effect assembly 30 and a lower Hall effect assembly 32 is magnetically coupled to the adjacent middle outer bands 28c, 28d to conduct electrical signals between a second pair comprising another electrical device 14 and another electrical device 15. Another pair of an upper Hall effect assembly 30 and a lower Hall effect assembly 32 is magnetically coupled to the adjacent middle inner bands 28e, 28f to conduct electrical signals between a third pair comprising another electrical device 14 and and another electrical device 15 as previously mentioned. Another pair of an upper Hall effect assembly 30 and a lower Hall effect assembly 32 is magnetically coupled to the adjacent inner bands 28g, 28h to conduct electrical signals between a fourth pair of another electrical device 14 and another electrical device 15. The system can include additional bands and Hall effect assemblies to accommodate more electrical devices 14 and 15.

As seen in FIG. 1, the conductivity of the magnetic circuits for the pairs of an upper Hall effect assembly 30 and a lower Hall effect assembly 32 is maintained throughout the complete 360 degree rotation of the steering wheel 12 due to the contactless connections between the Hall effect assemblies 30, 32 and the bands 28. Each of the upper Hall effect assemblies 30 can be at any position along its path of rotation but still be able to conduct electricity through its respective adjacent bands 28 and lower Hall effect assembly 32. The contactless connections between the Hall effect assemblies 30, 32 and the bands 28 also do not cause any stress to the system, since the contactless connections eliminate any bending or twisting of the system parts during the rotation of the steering wheel 12.

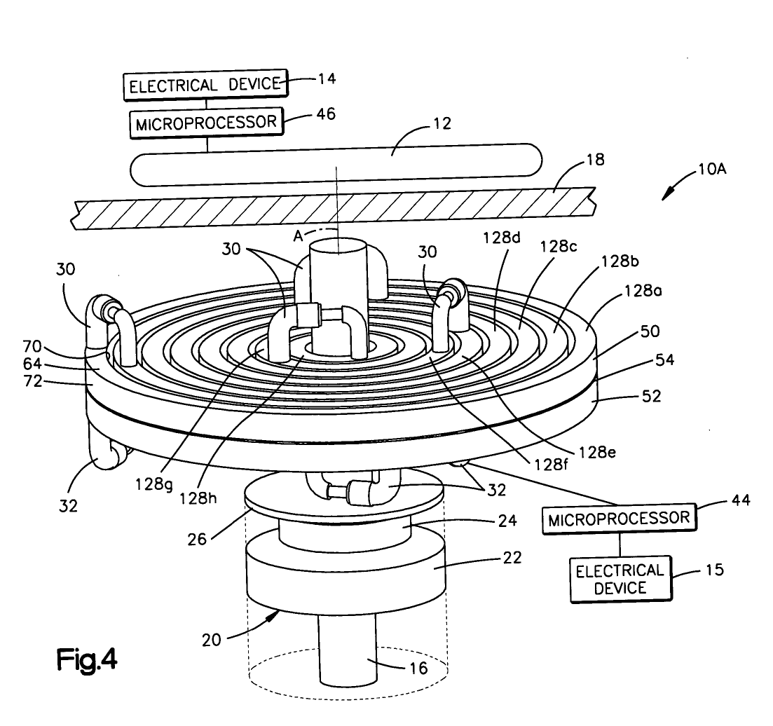

FIG. 4 illustrates a system 10A constructed in accordance with a second embodiment of the present invention. Structures of FIG. 4 that are the same as or similar to structures of FIG. 1 are numbered using the same reference numbers and are not discussed in detail with regard to FIG. 4.

The system 10A includes a plurality of concentric conductive bands 128a-h encircling the steering wheel shaft 16. The bands 128 are spaced apart from each other and connected to either the steering wheel shaft 16 or to the housing 18. All of the concentric bands 128 rotate together with the steering wheel shaft 16. The bands 28 are composed of a ferromagnetic material such as steel to carry magnetic flux. The conductive steel bands 128 are each split into upper and lower halves 50, 52. The halves 50, 52 are spaced apart from each other by a small air gap 54 that maximizes the magnetic permeance. The upper half rotates 50 with the steering wheel shaft 16 and the lower half 52 is fixed relative the steering wheel housing 18. Each of the upper Hall effect assemblies 30 is in contact and fixed to the upper half 50 of its associated two adjacent outer conductive bands 128 and each of the lower Hall effect assemblies 32 is in contact and fixed to the lower half 52 of its associated two adjacent bands 128.

In this case, the Hall effect assemblies 30, 32 can contact the bands without causing any stress to the system, because the air gap 54 allows each of the upper halves 50 to rotate with the steering wheel 12 and each of the lower halves 52 to remain fixed with respect to the steering wheel housing, while permitting electrical signals to conduct between the upper and lower halves 50, 52 of a band 128.

In both embodiments, the Hall effect devices 42 can also be enclosed in a ferrous enclosure to shield stray magnetic fields. Also, as a redundant backup to the system 10, signals can be superimposed on the driving voltage waveform of the primary coil 22 to transmit information across the conductive bands. Further, the feet angle, which is the angle that the Hall effect assembly forms with respect to the line extending between free ends 60, 62 of the Hall effect assembly if both free ends 60, 62 were positioned directly above or below the inner band of the two adjacent bands associated with the Hall effect assembly, can be adjusted to accommodate the various distances between adjacent bands associated with the Hall effect assembly. Each of the Hall effect assemblies 30, 32 and the other above-mentioned parts of the system 10 are enclosed by suitable plastic housings (not shown). The parts can be associated with the plastic housings by any suitable means such as by overmolding plastic to the part or by injecting an adhesive potting compound between the part and plastic housing.

The invention can include several modifications. For example, the bands can be connected to the housing 18, if the housing 18 rotates with the shaft 16. Also, instead of the standard unipolar switching device, each of the Hall effect devices 42 can be a linear device.

In another modification, the upper Hall effect assemblies 30 can be directly attached to the bands 28 without the need of the small air gaps 34, since the upper Hall effect assemblies 30 rotate with the bands 28. In still another modification, the lower Hall effect assemblies 32 can be secured to the steering wheel shaft 16 to rotate with the steering wheel shaft 16, and the upper Hall effect assemblies 30 can be secured to the housing 18 and not rotate with the steering wheel shaft 16.

From the above description of the invention, those skilled in the art will perceive improvements, changes and modifications. Such improvements, changes and modifications within the skill of the art are intended to be covered by the appended claims.

1. A system for conducting an electrical signal from a first device to a second device, which devices are relatively rotatable, said system comprising:
first and second Hall effect assemblies, said first Hall effect assembly being rotatable upon rotation of one of said devices, said first Hall effect assembly being activated to produce magnetic flux upon actuation of said one device, said second Hall effect assembly being associated with the other one of said devices; and
a ferromagnetic part interposed between said Hall effect assemblies to transmit said magnetic flux from one of the Hall effect assemblies to the other Hall effect assembly to provide an electrical control signal.

2. The system of claim 1 wherein said ferromagnetic part is rotatable relative to one of said Hall effect assemblies and including another ferromagnetic part rotatable relative to one of said first and second Hall effect assemblies and interposed between said Hall effect assemblies to transmit magnetic flux from one of the Hall effect assemblies to the other Hall effect assembly to provide an electrical control signal, wherein said first mentioned ferromagnetic part defines a first ring, said another ferromagnetic part defines a second ring spaced apart from said first ring and concentric with said first ring.

3. The system of claim 1 including a microprocessor coupled to said Hall effect assembly for processing the control signal.

4. The system of claim 1 wherein at least one of said first and second Hall effect assemblies is magnetically coupled to said ferromagnetic part without contacting said ferromagnetic part.

5. The system of claim 1 wherein said ferromagnetic part is separated into first and second sections by an air gap.

6. The system of claim 1 wherein said rotatable member is a steering wheel.

7. A system for conducting electricity to a non-rotatable electrical device in response to actuation of an actuator on a rotatable member rotatable relative to the electrical device, said system comprising:
a first ferromagnetic ring;
a second ferromagnetic ring spaced apart from said first ferromagnetic ring and concentric with said first ferromagnetic ring, said first and second ferromagnetic rings being rotatable with said rotatable member;
a Hall effect assembly electromagnetically coupled with said first and second rings which rings transmit magnetic flux; and
said Hall effect assembly and said first and second rings generating a control signal upon actuation of the actuator, which control signal triggers actuation of said electrical device.

8. The system of claim 7 including a microprocessor coupled to said Hall effect assembly for processing the control signal.

9. The system of claim 7 wherein said Hall effect assembly is magnetically coupled to said first and second rings without contacting said first and second rings.

10. The system of claim 7 wherein each of said first and second rings is separated into first and second sections by an air gap.

11. The system of claim 7 wherein said rotatable member is a steering wheel.

12. The system of claim 7 including a transformer operatively connected to said non-rotatable device.
